(19) United States
(12) Patent Application Publication
(10) Pub. No.: US 2026/0066757 A1
(43) Pub. Date: Mar. 5, 2026

(54) MUTLI-EXCITATON RESOLVER AND RELATED TECHNIQUES

(71) Applicant: The Charles Stark Draper Laboratory, Inc., Cambridge, MA (US)

(72) Inventors: Alan DUGAS, Cambridge, MA (US); Trey CRANNEY, Cambridge, MA (US); Oliver RAYNER, Cambridge, MA (US)

(73) Assignee: The Charles Stark Draper Laboratory, Inc., Cambridge, MA (US)

(21) Appl. No.: 18/819,434

(22) Filed: Aug. 29, 2024

(51) Int. Cl. H02K 24/00; H02K 11/00; H02K 11/30

(52) U.S. Cl. CPC H02K 24/00; H02K 11/0094; H02K 11/30

(57) ABSTRACT

Described is a multi-excitation resolver. In embodiments, a multi-excitation resolver includes a rotor having circuitry arranged to provide a one speed resolver and a multi-speed resolver. In embodiments, the rotor may be disposed proximate a surface of a stator such that a capacitive gap exists between a surface of the rotor and the surface of the stator. In embodiments, the stator includes circuitry which may produce quadrature output signals based upon interaction with the rotor circuitry. In embodiments, sensing conductors, output conductors and transmission conductors may be disposed on surfaces of the rotor and stator, respectively, such that a capacitance between the output conductors and the sensing conductors may be used to measure axial displacement.

### STATEMENT OF FEDERALLY SPONSORED RESEARCH

None.

### RELATED APPLICATIONS

Not applicable.

### BACKGROUND

As is known in the art, a resolver is a transducer that can be used in a wide variety of position and velocity feedback applications which includes light duty/servo, light industrial or heavy duty applications.

As is also known, conventional resolvers comprise a rotary transformer and provide an analog output signal. Excitation on a magnetic rotor generates modulated signals on stator coils. Position is encoded in quadrature signals. The number of coils in the rotary transformer is the “speed” of the resolver. Because of the inclusion of magnetics in the transformer, conventional electromagnetic resolvers are typically large, heavy, have a high-power draw and are bandwidth limited. Because the resolver is an analog device and the electrical outputs are continuous through one complete mechanical revolution, the theoretical resolution of a single-speed resolver is infinite.

Capacitive encoders are also known. Capacitive encoders comprise overlapping electrode plates which produce capacitors. The capacitance changes as a function of overlapping areas of the electrode plates. Capacitive encoders do not require a rotary transformer or heavy magnetic materials. While capacitive encoders have a low power draw relative to the power draw of a conventional electromagnetic resolver, capacitive encoders, have several drawbacks. For example, the area of the overlapping electrode plates can never be negative and thus output capacitance will always be positive which results in a rectified signal. This creates a repeating signal where unique information is only stored from 0° to 90° of a 360° rotation. Thus, the output signals must be combined (or “stitched”) together to form a full quadrature signal which gives unique positional information.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is an isometric view of a multi-excitation capacitive resolver provided in accordance with the concepts described herein;

FIG. 1B is a side view of the multi-excitation capacitive resolver of FIG. 1A;

FIG. 1C is a top view of a rotor suitable for use in a multi-excitation capacitive resolver such as the multi-excitation capacitive resolver of FIG. 1A;

FIG. 1D is a top view of a stator suitable for use in a multi-excitation capacitive resolver such as the multi-excitation capacitive resolver of FIG. 1A;

FIG. 2A is a top view of a rotor of single-speed resolver;

FIG. 2B is an enlarged view of a portion of the rotor of the single-speed resolver of FIG. 2A;

FIG. 2C is a further enlarged view of the portion of the rotor of the single-speed resolver shown in FIG. 2B;

FIG. 2D is an enlarged view of a portion of the rotor of the single-speed resolver shown in FIG. 2A;

FIG. 2E is a perspective view of a stator suitable for use with the single-speed rotor of FIG. 2A;

FIG. 3 is a diagram of an output of a multi-excitation capacitive resolver provided in accordance with the concepts described herein;

FIG. 4A is a diagram illustrating minimum single-speed resolver accuracy of a multi-excitation capacitive resolver provided in accordance with the concepts described herein;

FIG. 4B is an enlarged view of a portion of FIG. 4A;

FIG. 5 is a plot of voltage vs. angle illustrating full quadrature output signals of a multi-excitation capacitive resolver provided in accordance with the concepts described herein;

FIG. 6A is a top view of a multi-excitation capacitive resolver rotor;

FIG. 6B is an enlarged view of a portion of the multi-excitation capacitive resolver rotor of FIG. 6A.

FIG. 7A is a top view of a stator of a multi-excitation capacitive resolver;

FIG. 7B is a top view of the stator of a multi-excitation capacitive resolver having an overlaid sinusoidal rotor patterns to illustrate the relationship between the rotor circuitry and the stator circuitry;

FIG. 8A is an isometric cross-sectional view of a portion of a multi-excitation capacitive resolver configured as an axial displacement sensor.

FIG. 8B is a cross sectional view of the axial displacement sensor of FIG. 8A taken along lines 8B-8B in FIG. 8A

FIG. 8C is a perspective view of illustrating a first surface of a rotor;

FIG. 8D is a perspective view of illustrating a second surface of the rotor of FIG. 8C;

FIG. 8E is a top view of a stator;

FIG. 8F is a top transparent view of the rotor of FIG. 8E disposed over the stator of FIG. 8C;

FIG. 9A is a plot of signal output voltage vs. time for a first simulated output of a multi-excitation capacitive resolver;

FIG. 9B is a plot of signal output voltage vs. time for a second simulated output of a multi-excitation capacitive resolver;

FIG. 9C is a plot of voltage vs. angle which illustrates quadrant detection for a multi-excitation capacitive resolver;

FIG. 10 is a block diagram of a sensor comprising a multi-excitation capacitive resolver; and

FIG. 11 is a block diagram of example processing circuitry suitable for processing signals from a multi-excitation capacitive resolver.

### SUMMARY

Described is a multi-excitation capacitive resolver (or more simply a “multi-excitation resolver”). In embodiments, a multi-excitation resolver includes a rotor having circuitry disposed on one or more surfaces thereof with first portions of the circuitry arranged to provide an N speed resolver where N is an integer greater than or equal to 1 (N≥1). In embodiments, a multi-excitation resolver includes a rotor having circuitry disposed on one or more surfaces thereof with first portions of the circuitry arranged to provide a one speed resolver and second portions of the circuitry arranged to provide an N speed resolver (i.e. a multi-speed resolver) wherein N is an integer greater than or equal to 2 (N≥2). In embodiments, a surface of the rotor may be disposed proximate a surface of a stator such that a capacitive gap exists between the surface of the rotor and the surface of the stator. In embodiments, the stator includes circuitry which may produce quadrature output signals based upon interaction with the rotor circuitry. In embodiments, sensing conductors, output conductors and transmission conductors may be disposed on surfaces of the rotor and stator, respectively, such that a capacitance between the sensing conductors and the output conductors may be used to measure axial displacement. In embodiments, the rotor has first and second opposing surfaces and circuitry may be disposed on one or both surfaces of the rotor. The rotor circuitry may comprise a first set of conductors arranged to provide a one speed resolver and a second set of conductors arranged to provide a multi-speed resolver. In embodiments, the stator has first and second opposing surfaces and circuitry may be disposed on one or both surfaces of the stator. The circuitry may comprise a first set of conductors arranged to provide a one speed resolver and a second set of conductors arranged to provide a multi-speed resolver. As will become apparent from the description hereinbelow, in all embodiments described herein, the shape of conductors on the rotor and stator for both the one speed and multi-speed resolvers may be selected such that when certain ones of conductors of the rotor overlap certain ones of conductors of the stator, a sinusoidally varying overlapping area results.

In accordance with one aspect of the concepts, devices, systems and techniques described herein, a multi-excitation capacitive resolver includes a rotor having first and second opposing surfaces with a first surface of the rotor having first and second sets of conductors disposed thereon with the first set of conductors arranged to provide a one speed resolver and the second set of conductors arranged to provide a multi-speed resolver; and a stator having first and second opposing surfaces, with a first one of the first and second opposing surfaces disposed over the first surface of the rotor such that a capacitive gap exists between the first surface of the rotor and the first one of the first and second opposing surfaces of the stator.

With this particular arrangement, the technical solutions described herein disclose a multi-excitation capacitive resolver which provides full quadrature output signals. By using multiple excitations that are anti-phase to each other on each half of a given resolver period, a phase change is created when crossing the period. This results in the output of full quadrature signals. Thus, the anti-phase excitations in addition to amplitude modulation can make all four quadrants unique (i.e., 0° to 360° information is unique).

Furthermore, in a multi-excitation capacitive resolver provided in accordance with the concepts described herein, the single-speed has a minimum accuracy of one (1) period of the multi-speed resolver.

This means that in a multi-excitation capacitive resolver provided in accordance with the concepts described herein, it is possible to have more speeds than prior art devices which results in higher accuracy than prior art devices while using the same accuracy of single speed resolver to provide absolute position (i.e., the single speed resolver informs in which section of the multispeed one is located), due in part to the ability of the technical solutions proposed herein operating over 360 degrees. Thus, measurement resolution of a multi-excitation capacitive resolver provided in accordance with the concepts described herein is improved compared with a measurement resolution provided by conventional capacitive encoders while removing the magnetic components necessary of conventional resolvers.

### DETAILED DESCRIPTION

Before describing the details of a multi-excitation resolver, some introductory concepts are first explained. In general overview, a multi-excitation resolver provided in accordance with the concepts described herein includes at least one rotor and at least one stator. Some embodiments may include a single rotor and two or more stators. Some embodiments may include two or more rotors and a single stator. Some embodiments may include two or more rotors and two or more stators.

Each of the one or more rotors have excitation circuitry disposed on at least one surface thereof. The excitation circuitry is provided such that a first portion of the excitation circuitry can receive a first excitation signal through a first transmission path and a second portion of the excitation circuitry can concurrently receive a second excitation signal which is in antiphase with the first excitation signal through a second, different transmission path (i.e., the first and second transmission paths are electrically separate transmission paths). In embodiments, the first and second excitation signals may be provided, for example, from circuitry on a stator. Examples of such circuity are described below.

The first and second portions of the excitation circuitry are arranged to cooperate with circuitry on a stator to provide an N-speed resolver where N is an integer greater than or equal to 1 (N≥1). In embodiments, each of the one or more rotors have circuitry disposed on at least one surface thereof with a first excitation circuit (having first and second portions) arranged to provide a one speed resolver and a second excitation circuit (having first and second portions) arranged to provide a multi-speed resolver (i.e. an M-speed resolver where M is an integer greater than or equal to 2 (M≥2).

Since the excitation circuits are configured to concurrently receive excitation signals which are antiphase signals, the one-speed resolver is able to provide output signals which are unique in each quadrant of a 360 degree rotation of the one-speed resolver, thereby enabling the resolver to provide signals which uniquely identify rotor position around a 360 degree rotation. The multi-speed resolver provides 0-360 degrees of an arc length period which enables identification of a unique rotor position within a 360/N arc where N is the number of resolver speeds. Thus, the multi-speed resolver achieves four quadrant detection within each arc of the multi-speed resolver. For example, given a 16 speed resolver, four quadrant detection can be achieved within each 22.5 degree arc.

Also described herein is an axial displacement sensor which includes at least one rotor and at least one stator having one or more sensing conductors, one or more output conductors and one or more transmission conductors disposed on surfaces thereof such that a capacitance between the sensing conductors and the output conductor may be used to measure axial displacement.

Aspects and embodiments disclosed herein include devices, systems, methods and concepts for a multi-excitation resolver and an axial displacement sensor and are not limited in application to the details of construction and the arrangement of components set forth in the following description and/or illustrated in the drawings. After reading the disclosure provided herein, those of ordinary skill in the art will readily appreciate that the disclosed devices, systems, methods and concepts are capable of being practiced, implemented or carried out in various ways.

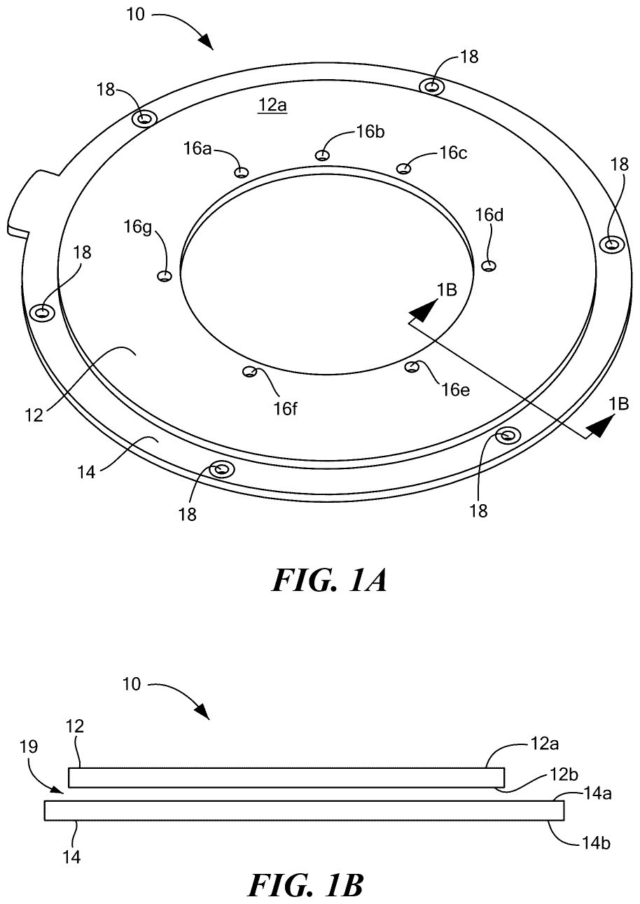

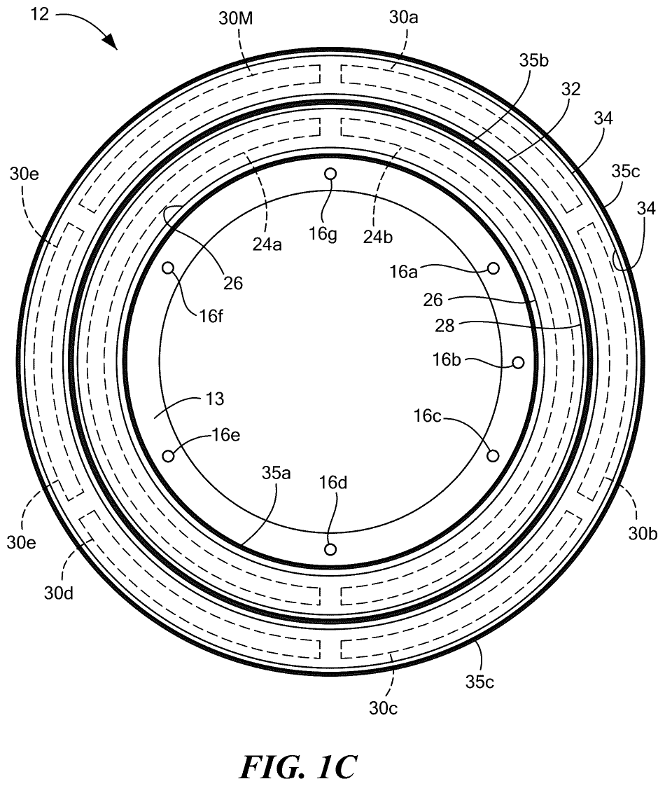

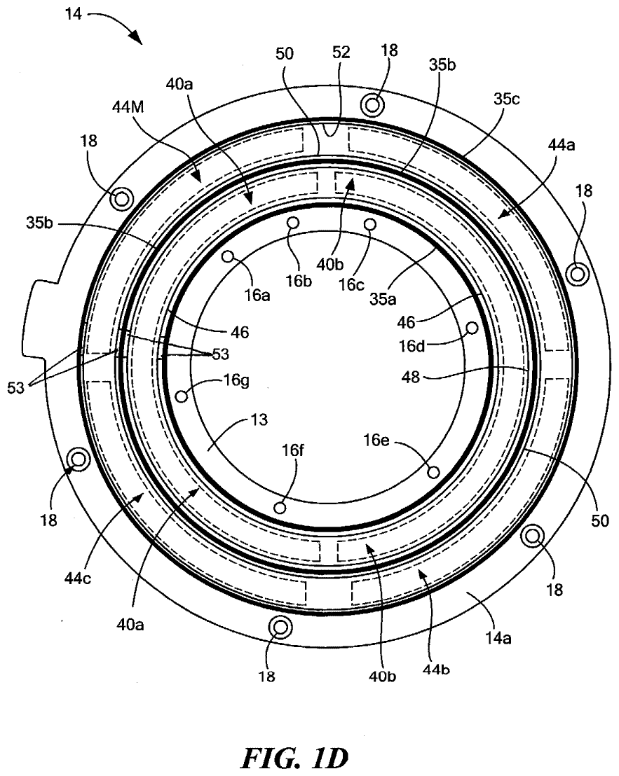

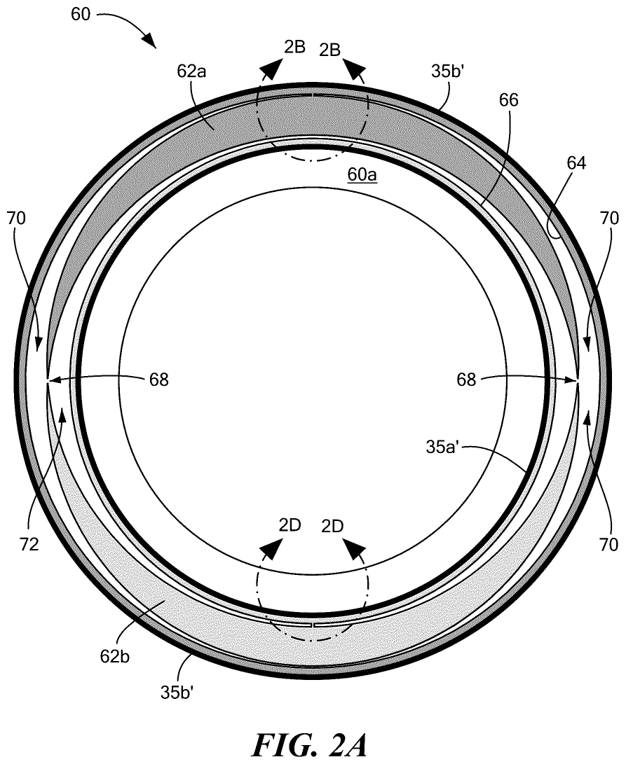

Referring now to FIG. 1A-1D in which like elements are provided having like reference designations, an example multi-excitation capacitive resolver 10 includes a rotor 12 having first and second opposing surfaces 12a, 12b disposed over a stator 14 also having first and second opposing surfaces 14a, 14b. The rotor 12 and stator 14 are arranged such that a first surface of the rotor (here surface 12b) is disposed over a first surface of the stator (here surface 14a). The rotor 12 can rotate relative to the stator. In embodiments, the rotor can rotate by at least 360° relative to the stator.

In embodiments, the rotor and stator are concentrically stacked (e.g. as shown in FIGS. 1A-1D).

After reading the disclosure provided herein, however, it will be recognized by those of ordinary skill in the art that in embodiments, the concepts and techniques described herein can be used to provide a linear resolver. In this case, the system may not be concentric (i.e. a rotor and stator may not be concentrically disposed as illustrated in FIGS. 1A-1D). Rather, a device similar to the rotor, but moving linearly or in other non-rotational movement e.g. a “linear rotor” and stator would be aligned linearly. Such an embodiment could be used, for example, to measure a travel distance of an object (e.g. a stage such as a reticle stage in a semiconductor processing system) along a single axis. The concepts and techniques described herein can thus be used to provide at least some functionalities of a Linear Variable Differential Transformer (LVDT) (i.e., a device which is based upon linear motion vs rotational motion). Such a device would provide benefits similar to the benefits provided by a rotational device such as the rotational devices described at least in conjunction with FIGS. 1A-2E and 6A-8F. Accordingly, the concepts described herein may be applied to rotor and stator structures configured for rotational movement as well as rotor and stator structures configured for non-rotational movement (e.g., linear movement).

Rotor 12 and stator 14 each comprise a generally planar plate (or substrate) portion and a hub portion 13 (FIG. 1C). Mounting holes 16a-16g may optionally be provided in the hub portion of the rotor and stator and may be used (along with appropriately selected and sized bolts or screws or other fasteners) for mounting or otherwise securing together the stator and rotor. Other techniques (i.e., other than fasteners) for securing the stator and rotor together may, of course, also be used.

The stator 14 also includes optional mounting holes 18 for mounting the stator to other structures. Depending upon the needs of the particular application, other techniques for securing the stator and/or the rotor to objects (e.g., moving or non-moving objects) may also be used.

As illustrated in FIG. 1B, a fixed space (or gap) 19 is maintained between rotor surface 12b and stator surface 14a (i.e., the rotor surface and stator surface are spaced apart) such that a capacitive gap 19 exists between rotor surface 12b and stator surface 14a. The spacing 19 between rotor and stator surfaces may be established using a spacer (e.g., a mechanical structure) or can also be established, for example, by mounting a first one of the stator or rotor to a first structure and a second one of the stator or rotor to a second different structure which is spaced apart from the first structure. For example, the stator may be mounted to a fixed position (e.g. a stationary structure) and the rotor may be mounted to a moving object (e.g. a rotating shaft).

It should be appreciated that capacitance is, at least in part, a function of gap width 19 (i.e. the spacing between a rotor surface and a stator surface). In embodiments, a gap width (or more simply “a gap”) which is as small as practical may be preferred. In embodiments the gap width may range from a width of about 0.3 mm to about 1 mm. It should, of course, be appreciated that in some embodiments gap widths less 0.3 mm may be preferred while in other embodiments gap widths greater than or equal to 1 mm may be preferred. After reading the disclosure provided herein, one of ordinary skill in the art will appreciate how to select a spacing (or gap) between a surface of a rotor and a surface of a stator. In general, there is an inverse relationship between gap width and detected level signal—i.e. the larger (or wider) the gap width, the smaller the detected signal level.

It is also appreciated that when a multi-excitation resolver provided in accordance with the concepts described herein is provided having a relatively large gap between rotor and stator surfaces (i.e., a wide gap width 19) the flatness of rotor and stator surface may have less impact on resolver performance as compared to resolvers having a relatively small gap (i.e., a small gap width 19). Thus, resolvers having a relatively large gap may also utilize larger surface flatness and warp tolerances of the rotor and stator.

The width of gap 19 (in combination with a dielectric material and respective overlapping resolver speed areas) between the co-planar surfaces 12b, 14a defines a capacitance and may affect electronic signal conditioning. As such, multi-excitation resolvers as well as sensors described herein may be configured with gaps of varying sizes, with respective speed areas of varying sizes, and dielectric properties depending upon the needs of a particular application. Non-coplanarity (e.g. rotor and stator surfaces which are not co-planar) may contribute a time and/or position dependent error. However, if such non-coplanarity is repeatable, it could be calibrated and thus have small or even no effect on resolver performance. In at least some embodiments, however, it may be preferable that gap widths and dielectric properties within the gap be uniform.

In this example embodiment, the gap is an air gap. More generally, however, gap 19 may be filled with a gas or other fluid or a solid or semi-solid dielectric material. In embodiments, one or more dielectrics may fill all or portions of the gap. In embodiments, a spacer (not illustrated in FIG. 1A-1C) may be disposed between all or portions of the rotor surface and stator surface to establish and maintain a desired spacing (and/or a desired tolerance of the spacing) between the two surfaces (i.e., one or more spacer elements or devices may be used to maintain a gap between rotor and stator surfaces within a desired range of distances). Thus, a spacer may be disposed to position the first surface of the rotor and the first one of the first and second opposing surfaces of the stator a selected distance apart. In embodiments, the spacer may be provided from a dielectric material or other material.

At least one first surface of rotor 12 (here, surface 12b) has circuitry disposed thereon with the circuitry arranged to cooperate with stator circuitry to provide an N-speed speed resolver where N is an integer greater than or equal to 1. In embodiments, the rotor circuitry may be in the form of at least one set of conductors.

In this example embodiment, rotor surface 12b has circuitry in the form of first and second sets of rotor circuitry (24a, 24b, 26, 28, and 30a 30M, 32 and 34, respectively) disposed thereon. The first set of rotor circuitry 24a, 24b, 26 and 28 arranged to provide a first N-speed resolver and the second set of rotor circuitry 30a-30M, 32 and 34 arranged to provide a second, different N-speed resolver. Thus, with N=1, for example, the first set of rotor circuitry 24a, 24b, 26 and 28 is arranged to provide a one-speed resolver and with N=16, for example, the second set of rotor circuitry 30a-30M, 32 and 34 is arranged to provide a 16-speed resolver.

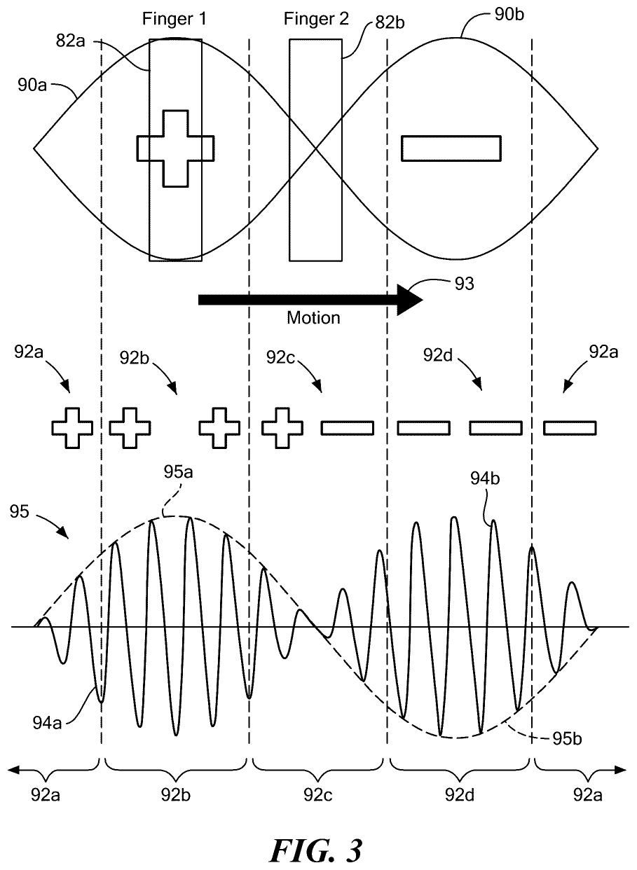

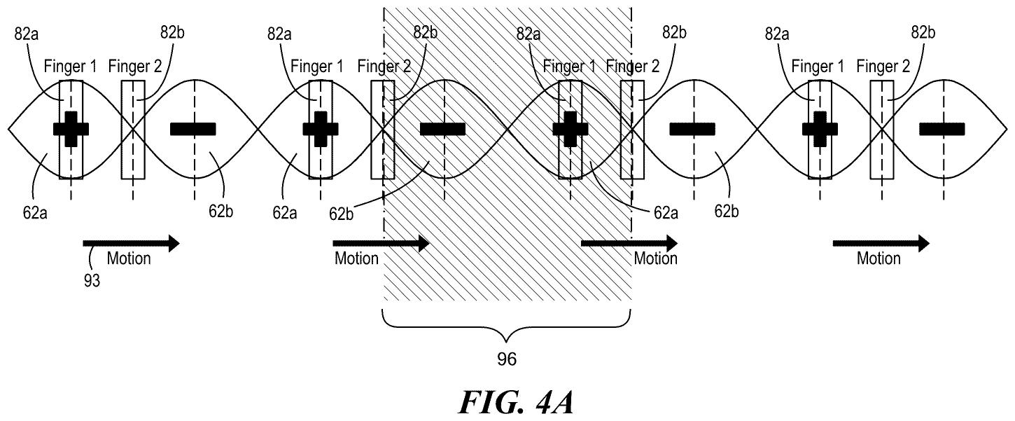

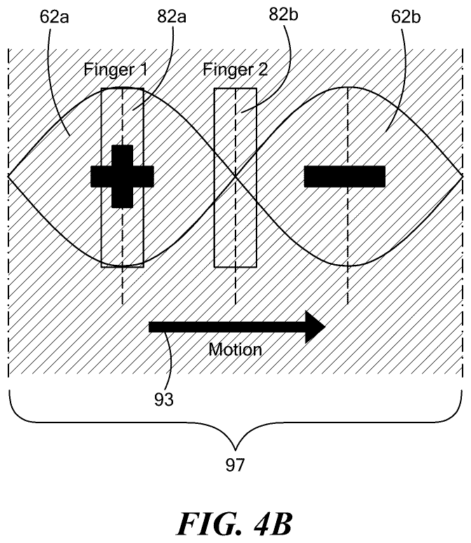

The first set of rotor circuitry 24a, 24b, 26, and 28 can include a single-speed rotor excitation circuit, here comprising two rotor excitation circuits 24a, 24b which are electrically isolated from each other. Examples of specific implementations of single-speed excitation circuits are described hereinbelow. As will become apparent from the description herein below, in embodiments, single-speed excitation circuits may be provided from conductors having a wide variety of sizes and shapes (e.g. sinusoidal shapes, rectangular shapes or any regular or irregular geometric shapes). Such conductors may be disposed on one or more surfaces of a rotor substrate. After reading the description provided herein, one of ordinary skill in the art will appreciate that regardless of the particular shape of a rotor excitation circuit or a stator circuit, the overlap of the circuits provided on the rotor and the stator are selected to produce output signals having a sinusoidal or generally sinusoidal shape (e.g., as will be describe below in conjunction with FIGS. 3 and 4A, for example).

Thus, single-speed rotor excitation circuits 24a, 24b may be provided from conductors which (in some cases, in combination with stator circuitry) produce output signals having sinusoidal or generally sinusoidally varying shapes. In some cases, the output signals can be formed by the single-speed rotor excitation circuits 24a, 24b sinusoidally varying overlapping capacitive plate areas, such as in combination with stator circuitry described herein.

First portions of single-speed excitation circuit 24a are coupled to a first single-speed transmission circuit 26. Second portions of single-speed excitation circuit 24b are coupled to a second single-speed transmission circuit 28. When transmission circuits 26, 28 are provided having an annular shape (as shown in FIG. 1C), the transmission circuits may sometimes be referred to herein as a “transmission annular. ” In embodiments, transmission circuits 26, 28 may be provided as conductors. Such conductors may be disposed on one or more surfaces of a substrate.

The multi-speed resolver comprises a multi-speed excitation circuit 30a-30M. In embodiments, multi-speed excitation circuit 30a-30M may comprise a plurality of circuits, here illustrated as M circuits 30a-30M (where M is an integer greater than or equal to 2) which are electrically isolated from each other. Examples of specific multi-speed excitation circuits are described hereinbelow. However, suffice it here to say that multi-speed excitation circuits 30a-30M may be provided from conductors which provide sinusoidal or generally sinusoidally varying shaped output signals. For example, a sinusoidal-varying shaped output can include one or more angularly dependent amplitude sinusoids generated by varying capacitive plate areas.

First portions of multi-speed excitation circuitry 30a-30M are coupled to a first multi-speed transmission circuit 32. In the example embodiment of FIG. 1C, transmission circuit 32 is illustrated as having an annular shape and thus may sometimes be referred to as a “transmission annular”. Second portions of multi-speed excitation circuitry 30a-30M are coupled to a second rotor multi-speed transmission circuit 34 (or “transmission annular”). Shielding circuits 35a-35c, generally denoted 35, (and also sometimes referred to herein as “shield annulars” or “ground annulars” due to the annular shape illustrated in the example of FIG. 1C) are disposed among and/or between the transmission circuits and the excitation circuits 24a, 24b, 30a-30M to shield such circuits from stray and/or extraneous signals.

Referring now to FIG. 1D, the stator 14 comprises circuitry selected to cooperate with the rotor circuitry described above (e.g., circuitry 24a, 24b, 26, and 28 and 30a 30M, 32 and 34) to produce an analog resolver output signal. Stator circuitry may be disposed on at least one of the first and second opposing surfaces of the stator. In the example embodiment of FIG. 1D, to promote clarity in the drawings and description, stator circuitry is illustrated as being disposed on stator surface 14a to interact and cooperate with the circuitry disposed on one or more surfaces of a rotor (e.g., circuitry disposed on rotor surface 12b in FIG. 1C) It should, of course, be appreciated that in some embodiments it may be preferred or even necessary that stator circuitry be disposed on stator surface 14b or that in some embodiments it may be preferred or even necessary that some stator circuitry is disposed on both stator surface 14a and stator surface 14b (i.e., some stator circuitry may be disposed on stator surface 14a and some stator circuitry may be disposed on stator surface 14b).

With a rotor configured as shown in FIG. 1C (i.e., a rotor having a pair of excitation circuits 24a, 24b, 30a-30M), stator 14 as shown in FIG. 1D includes a first and second stator circuitry with the first stator circuitry comprised of stator circuits 40a, 40b which are disposed to cooperate with the rotor circuitry 24a, 24b of rotor 12 (FIG. 1C). Stator 14 (FIG. 1D) also includes second stator circuitry comprised of stator circuits 44a-44M disposed to cooperate with the second rotor excitation circuitry 30a-30M of rotor 12 (FIG. 1C).

Stator 14 further comprises first and second stator transmission circuits 46, 48 (also sometimes referred to as “coupling circuits” or when the circuits 46, 48 are provided having an annular or partially annular shape referred to as “coupling annulars”). Stator transmission circuits 46, 48 may each provide (e.g., transmit, couple or otherwise provide) a signal from the stator to the rotor. Ideally, transmission circuits 46, 48 are selected such that they do not substantially change or vary the characteristics (such as amplitude, phase, period, etc.) of signals being provided to the rotor. In the example of FIG. 1D, stator transmission circuits 46, 48 are disposed to capacitively couple signals to respective ones of second rotor multi-speed transmission circuits 32, 34 (FIG. 1C).

Stator 14 further comprises third and fourth stator transmission circuits 50, 52 circuits (also sometimes referred to as “coupling circuits” or when the circuits 50, 52 are provided having an annular or partially annular shape referred to as “coupling annulars”) disposed to couple (e.g., capacitively couple) to respective ones of rotor circuits 26, 28.

As indicated by reference numeral 53, in some embodiments, a break or gap may optionally be provided in some or all of transmission circuits 46, 48, 50, 52. Such a gap could be used to facilitate routing of signals and/or signal paths (e.g., a connection point), in embodiments comprising a two-layer printed circuit board, for example. In other embodiments (e.g. as shown in FIG. 1D), transmission circuits 46, 48, 50, 52 are continuous (i.e., without a break or gap). It is noted that in all embodiments, vias may be used to facilitate routing of signals and/or signal paths or as connection points.

In this example embodiment, shielding circuits 35a-35c are disposed among and/or between the circuits 40, 44, 46, 48, 50 and 52.

Thus, with this arrangement of circuitry, signals may be applied to stator circuits 46, 48, 50, 52 (here illustrated as having annular shapes) and capacitively coupled to respective ones of rotor circuits 26, 28, 30, 32.

The stator also comprises an input for receiving one or more excitation signals on circuits 46, 48, 50, 52. In the case of multiple excitation signals, the stator input receives one or more excitation signals that are out-of-phase to each other (e.g., antiphase or substantially anti-phase to each other) on each half of a resolver period such that in response to receiving multiple excitation signals, an output signal of the resolver generates a phase change while traversing the resolver period.

That is, in operation, multiple excitations that are anti-phase to each other may be applied to each half of the resolver period. This results in a phase change when crossing the period and consequently results in the multi-excitation capacitive resolver providing output signals corresponding to full quadrature signals. Accordingly, by applying multiple excitation signals that are anti-phase to each other on each half of the resolver period creates a phase change when crossing the period which allows the multi-excitation capacitive resolver to produce full quadrature output signals.

In embodiments, stator 12 and the rotor 14 of multi-excitation resolver 10 may comprise printed circuit boards (PCB's). It should, however, be appreciated that stator 12 and rotor 14 of a multi-excitation resolver 10 may comprise any substrate or structure having sufficient mechanical properties for use in an intended application and on which may be disposed rotor and stator circuitry described above and hereinbelow. Suitable materials from which to provide a rotor and/or stator (in whole or in-part) include, but are not limited to materials which comprise PTFE, FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (non-non-woven glass and epoxy) CEM-4 (woven glass and epoxy), CEM-5 (woven glass and polyester), ceramic filled PTFE, RF-35 (fiberglass-reinforced ceramics-filled PTFE); alumina; polyimide; polyimide-based materials; aluminum; silicon and Silicon Oxides, sapphire or other crystal substrates, or amorphous substrates (including but not limited to glass and borosilicate) and insulated metal substrate (IMS).

It should be appreciated the aforementioned circuitry may be disposed on one or more surfaces of the rotor and stator using any one or any combination of techniques known to those of ordinary skill in the art including any additive technique (e.g. sputtering) or subtractive technique (e.g. etching). In embodiments, at least portions of the rotor and stator may be provided using additive manufacturing techniques (e.g. 3D printing techniques).

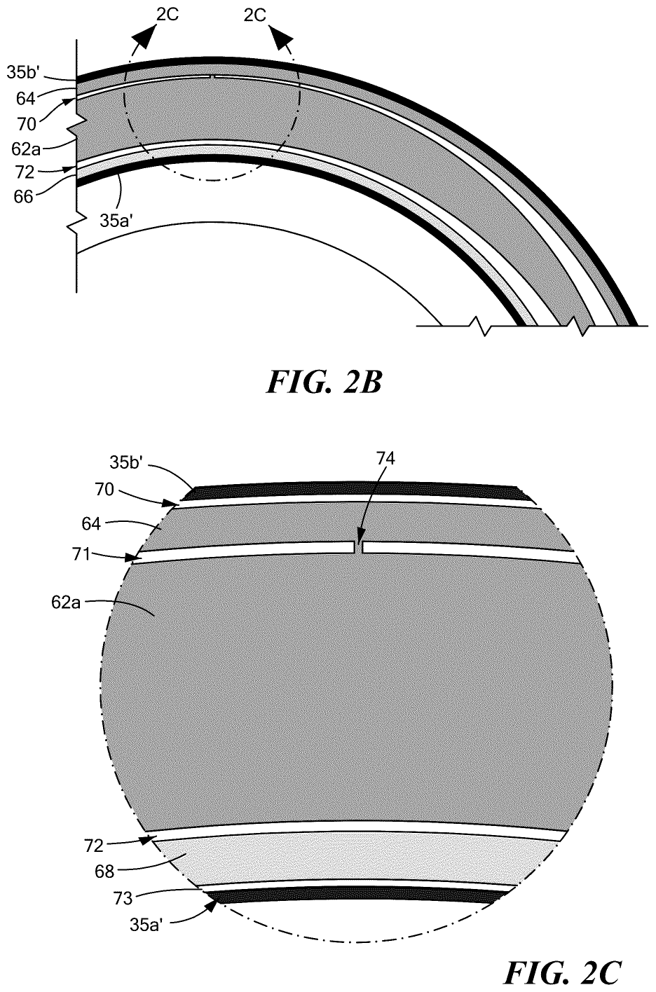

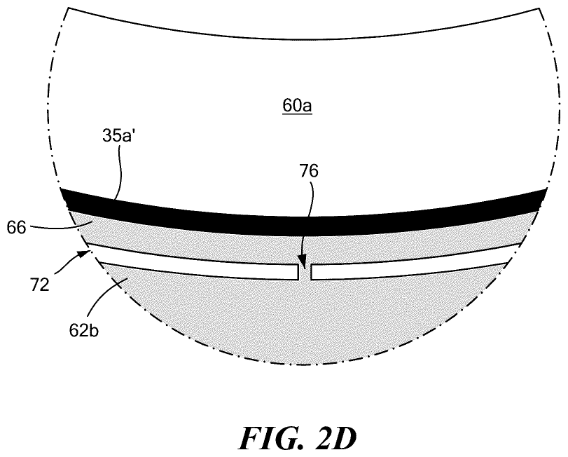

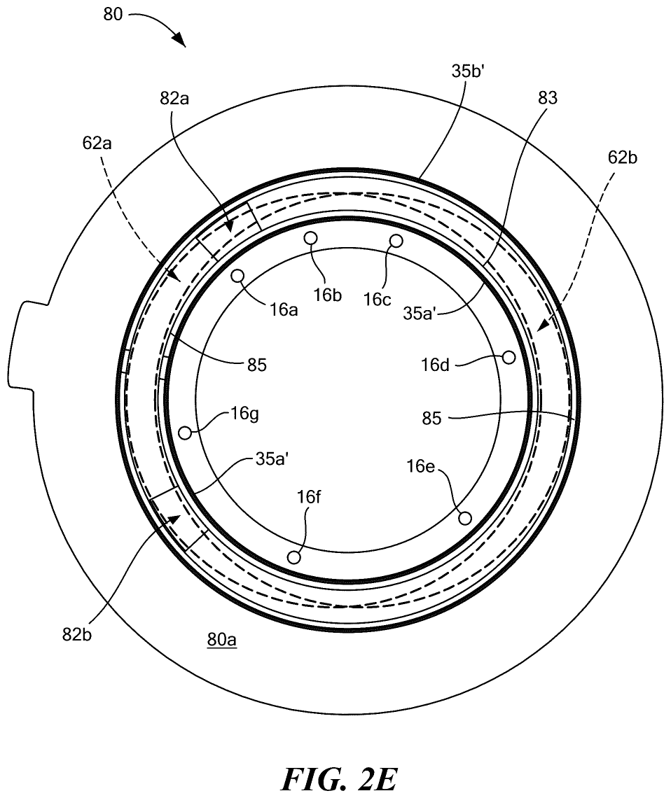

Referring now to FIGS. 2A-2E in which like elements are provided having like reference numerals throughout the several views, a rotor 60 suitable for use in a resolver, has a first surface on which is disposed one-speed resolver circuitry. In this example embodiment, one-speed resolver circuitry comprises a single-speed excitation circuit 62 comprising a pair of conductors 62a, 62b. In this example embodiment conductors 62a, 62b have a generally curved or generally sinusoidal shape (e.g., a shape which can be plotted using the sine or cosine function). In the example of FIGS. 2A-2E, each conductor 62a, 62b may be considered one-half of a sinusoid.

After reading the disclosure provided herein, those of ordinary skill in the art will appreciate that conductors 62a, 62b may also be provided having other shapes. As will become apparent from the description herein, the shape of conductors 62a, 62b may be selected such that when rotor conductors 62a, 62 overlap with conductors of the stator (e.g., conductors 82a, 82b to be described below in conjunction with FIG. 2E), a sinusoidally varying overlapping area results. Thus, it may be said that rotor conductors (e.g., conductors 62a, 62b) are provided having a substantially sinusoidally varying shape with respect to stator conductors (e.g., stator conductors 82a, 82b shown in FIG. 2E).

Conductors 62a, 62b are electrically isolated from each other (i.e., conductors which form single-speed excitation circuits 62a, 62b are not in physical contact; rather they are spaced apart from each other via gaps 68).

Single-speed excitation conductor 62a is coupled to a first single-speed transmission circuit here provided as a conductor 64 (and thus sometimes referred to as a single-speed transmission conductor) through a conductor 74 (FIG. 2C). Similarly, single-speed excitation conductor 62b is coupled to a second, different single-speed transmission circuit here provided as a conductor 66 via a conductor 76 (FIG. 2D).

While transmission conductors 64, 66 are coupled (via respective ones of conductors 74 (FIGS. 2C) and 76 (FIG. 2D)) to respective excitation conductors 62a, 62b, the transmission conductors 64, 66 are not in physical contact with each other. Thus, first and second portions of the single-speed excitation conductors are independently electrically coupled to respective ones of independent and separate transmission conductors 64, 66. Stated differently, excitation conductors 62a, 62b of the single-speed resolver are independently electrically coupled to respective ones of separate transmission conductors 64, 66.

As may be most clearly seen in FIGS. 2B-2D, the rotor also has disposed thereon shielding conductors 35a′, 35b′ (functionally corresponding to shielding circuits 35a, 35b discussed in conjunction with FIGS. 1A-1D).

As may be most clearly seen in FIGS. 2C and 2D, shielding conductor 35b′ is spaced apart from transmission conductor 64 by a first gap 70 (FIG. 2C) and transmission conductor 64 is spaced apart from first excitation conductor 62a by a second gap 71. A signal path provided by conductor 74 (FIG. 2C) couples excitation conductor 62a to first transmission conductor 64.

Excitation conductor 62a is also spaced apart from transmission conductor 66 by a fourth gap 72 (FIGS. 2B, 2C). A signal path provided by conductor 76 (FIG. 2D) couples second excitation conductor 62b to second transmission conductor 66.

Referring now to FIG. 2E, a stator 80 comprises a first set of conductors 82a, 82b disposed on a first one of the first and second opposing surfaces of the stator (here surface 80a). Conductors 82a, 82b form first and second single-speed output pickup conductors 82a, 82b (also sometimes also referred to herein as “sensing electrodes” or “fingers”) to thus cooperate with the single-speed excitation conductors 62a, 62b of FIGS. 2A-2D.

In FIG. 2E, the single-speed excitation conductors 62a, 62b have a shape corresponding to sinusoidal or partial sinusoidal patterns. It should be appreciated that in FIG. 2E excitation conductors 62a, 62b are shown in phantom since in this example, the excitation conductors 62a, 62b are not properly a part of the stator but are shown overlaid on the stator 80 merely to illustrate the physical relationship between the sinusoidal excitation conductors 62a, 62b and the output pickup conductors 82a, 82b on the surface 80a of the rotor 80. As illustrated in FIG. 2E, each output pickup conductor 82a, 82b is disposed to intercept at least portions of the sinusoidal patterns of conductors 62a, 62b as the output pickup conductors 82a, 82b and conductors 62a, 62b move relative to each other (e.g. past each other in the case where the rotor turns relative the stator). Those of ordinary skill in the art will thus appreciate that in this example embodiment, rotor excitation conductors 62a, 62b are formed or otherwise provided on one or more surfaces of the rotor rather than on one or more surfaces of the stator and output pickup conductors 82a, 82b are formed or otherwise provided on one or more surfaces of the stator rather than on one or more surfaces of the rotor.

Also provided on the stator are circuits (or “annulars”) implemented as conductors 83, 85 which are disposed such that a capacitive coupling exists with respective ones of transmission conductors 64, 66. The stator couples or otherwise provides antiphase excitation signals to the rotor using the capacitively coupled conductors 83, 85. The antiphase excitation signals are sometimes denoted herein as “Exc” and “E̅x̅c̅” where the notation Exc and E̅x̅c̅ (or “Exc-bar”) denotes the signals are in antiphase.

Since the rotor excitation conductors 62a, 62b have a varying shape (here, having a generally sinusoidal shape), in response to the excitation conductors 62a, 62b moving relative to the output pickup conductors 82a, 82b, the capacitance over the output pickup conductors changes due to the varying amounts of conductors which overlap (i.e., the physical area of overlap between the excitation conductors 62a, 62b and the output pickup conductors 82a, 82b changes as the conductors 62a, 62b move past the conductors 82a, 82b).

The changing capacitance between output pickup conductors 82a, 82b and the pattern of the excitation conductors 62a, 62b generates quadrature signals encoding a rotation angle. Thus, with excitation conductors 62a, 62b having a generally sinusoidally varying shape, the output pickup conductors 82a, 82b are sometimes referred to as Sine (SIN) and Cosine (COS) pickup conductors.

In operation, and as will be described in detail in conjunction with FIGS. 3-5B, a first excitation sinusoid signal (Exc) may be applied to a first excitation conductor 62a and a second excitation signal Exc in antiphase to the first excitation signal (Exc) may be applied to a second excitation conductor 62b).

The first and second excitation conductors 62a, 62b in combination with output pickup conductor 82a, 82b generates a pair of output signals having phase shifts which allow the resolver to provide quadrature output signals encoding rotation angle.

It should be appreciated that while the embodiment of FIGS. 2A-2E illustrates a rotor and stator which form a single-speed resolver, the same approach can be used to form a multi-speed resolver.

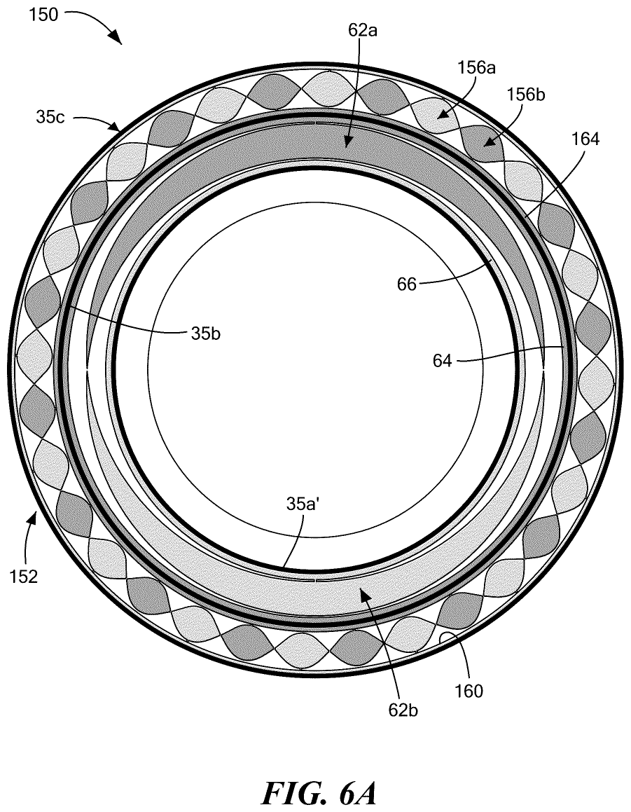

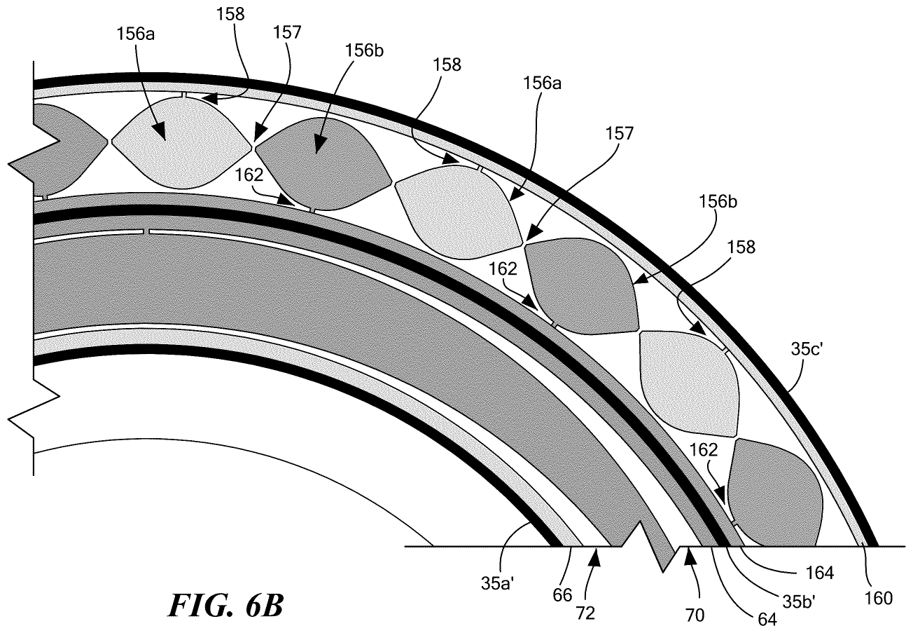

That is, rather than providing a single-speed resolver, more generally the patterns (i.e. shapes or designs) of circuits such as conductors 62 and 80 may be selected to provide an N-speed resolver where N is an integer greater than or equal to 1. Furthermore, the rotor and stator may be configured such that multiple excitation conductors are provided on the rotor and a corresponding number of output pickup conductors are provided on the stator. FIG. 6A-9C below illustrate an example embodiment with excitation conductors having two different speeds (i.e., a one speed resolver and a 16-speed resolver). However, it is possible to provide rotors (and corresponding stators) having three (3) or more different speeds (i.e., rotors having three or more different speeds of excitation conductors and stators having a corresponding number of output pickup conductors which cooperate with the excitation conductors to form resolver signals.

Referring now to FIG. 3, in operation, a first excitation signal 90a may be applied to a first excitation circuit (e.g. a first one of rotor excitation conductors 62a, 62b in FIGS. 2A-2D), and a second excitation signal 90b, which is in antiphase to the first excitation signal 90a (i.e., signals 90a, 90b are 180° (or π radians) out of phase), may be concurrently applied to a second excitation circuit (e.g. a second one of rotor excitation conductors 62a, 62b in FIGS. 2A-2D).

As the excitation circuits (e.g., excitation conductors 62a, 62b as may be provided on a rotor) move past sensing conductors (e.g., sensing conductors 82a, 82b as may be provided on a stator) in a direction, a phase shift occurs in each quadrant boundary 92a-92d with quadrant 92a having a phase of −+, which when moving to quadrant 92b shifts to ++, moving to quadrant 92c can enable a shift to phase +−, and quadrant 92d having a phase of −−.

As illustrated in FIG. 3, this results in a unique phase relationship existing in each ninety degree (90°) quadrant (denoted 92a-92d in FIG. 3) of a 360 degree rotation of the rotor relative the stator (e.g., each 360 degree rotor rotation). Thus, the use of dual excitation signals 90a, 90b results in all four quadrants 92a-92d having unique phase relationships which in turn results in the 0° to 360° information supplied by a resolver provided in accordance with the concepts described herein being unique).

Accordingly, when a rotor having generally sinusoidally shaped excitation circuits moves past stator output pickup conductors in a direction of motion (indicated by reference numeral 93 in FIG. 3), due to the unique phase in each quadrant, it is possible to encode 0 to 360 degrees of rotation. In this way, the output of the capacitive resolver design described herein can produce an analog output signal similar to that produced by an electromagnetic resolver.

By using multiple excitations that are anti-phase to each other on each half of the resolver period, a phase change is created when crossing the period as illustrated by curve 95 where a portion 95a of curve 95 has a first phase (e.g. a positive phase) and a portion 95b of curve 95 has a second phase (e.g. a negative phase). This results in the output of full quadrature signals by multi-speed capacitive resolvers provided in accordance with the concepts described herein.

Referring now to FIG. 4A, for an example of a multi-excitation, multi-speed capacitive resolver provided in accordance with the concepts described herein, the single-speed can have a minimum accuracy of 1 period of the multi-speed as indicated by reference numeral 96. It should be appreciated that this “minimum” is to determine absolute angle. In embodiments in which only relative angle is of interest, minimum accuracy is not relevant.

Referring now to FIG. 4B, it should also be noted that the accuracy of the one-speed resolver (i.e., minimum single-speed resolver accuracy as indicated by reference numeral 97 in FIG. 4B) is dictated by an analog-to-digital converter (ADC) bit count. The higher the bit count the more accurate the single-speed is.

In a multi-excitation, multi-speed resolver as described herein, a single-speed resolver can identify a location within an entire rotation. The multi-excitation resolver designs described herein allow a user to achieve higher resolution and lower cost. In this way, it is possible to achieve output signals and resolutions similar to that of conventional magnetic resolvers, without the excessive mechanical bulk or magnetics of the conventional magnetic resolvers, enabling a decrease in size, weight, power, and materials. Furthermore, this can enable the use of the presented capacitive resolver as a drop-in replacement for existing magnetic resolvers without the need for additional signal processing at the output, as may be necessary with some conventional capacitive encoders.

For example, in a multi-excitation resolver, an ADC accuracy sufficient to resolve one (1) period within the single speed resolver is required.

In embodiments, the minimum accuracy of the single-speed resolver is less than or equal to one period of the multispeed resolver and in some embodiments in the range of about 3/4 period of the multi-speed resolver.

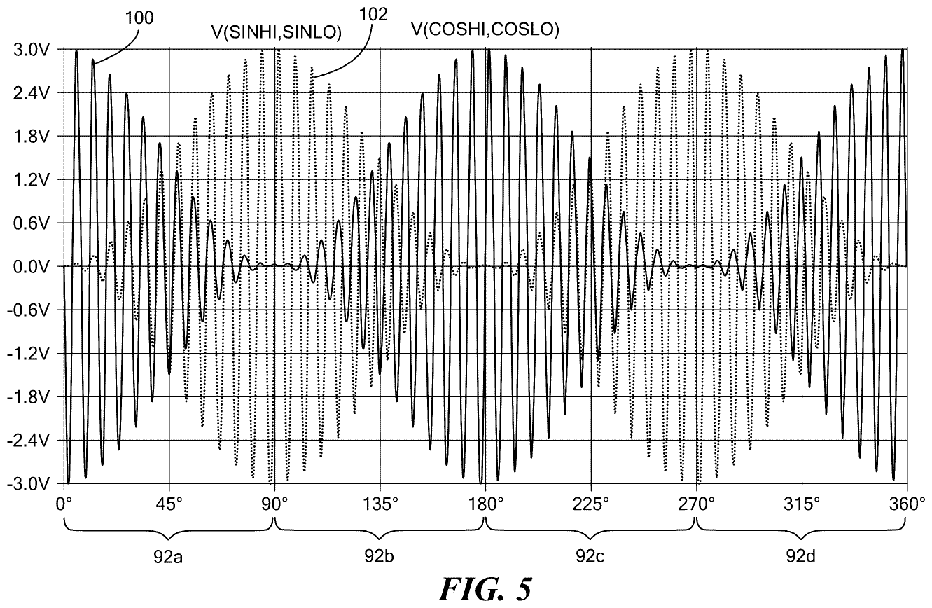

Referring now to FIG. 5,, curves 100, 102 correspond to output signals of a multi-excitation capacitive resolver provided in accordance with the concepts described herein (e.g. in response to excitation signals such as those illustrated in FIG. 3. As illustrated in FIG. 5, the multi-excitation capacitive resolver provides a full quadrature output signal which is substantially identical to output signals provided by electromagnetic resolvers. Thus, FIG. 5 illustrates that signals provided by a multi-excitation capacitive resolver provided in accordance with the concepts described herein are compatible with existing resolver electronics and software (i.e., a multi-excitation capacitive resolver provided in accordance with the concepts described herein provides a backward compatible quadrature signal). And hence, a multi-excitation capacitive resolver provided in accordance with the concepts described herein may be a direct replacement (i.e., a “drop-in place replacement”) for many existing systems.

Referring now to FIGS. 6A, 6B in which like elements are provided having like reference designations, a rotor 150 of a multi-excitation resolver provided in accordance with the concept described herein comprises a first set of conductors for a one-speed (1-speed) resolver and a second set of conductors for a sixteen speed (16-speed) resolver. Such conductors may be disposed on one or both surfaces of a rotor substrate 152. It should be appreciated that rotor substrate 152 has first and second opposing surfaces (with the second opposing surface not visible in FIGS. 6A, 6B) and that in this example embodiment, for ease of illustration and to promote clarity in the description, all rotor conductors are shown as being provided on one surface of the rotor substrate.

It should, however, be appreciated that in some embodiments, it may be desirable to provide all or portions of the first and second circuitry on opposing surfaces of the rotor substrate. For example, all circuity for the 1-speed resolver may be provided on a first surface of the rotor substrate while all circuity for the 16-speed resolver may be provided on the second, opposing surface of the rotor substrate. As another example, some portions of the conductors for the 1-speed resolver may be provided on a first surface of the rotor substrate and other portions of the circuity for the 1-speed resolver may be provided on the second, opposite surface of the rotor substrate. As another example, some portions of the circuity for the 16-speed resolver may be provided on a first surface of the rotor substrate and other portions of the circuity for the 16-speed resolver may be provided on the second, opposite surface of the rotor substrate. As yet another example, some portions of the conductors for both the 1-speed resolver and the 16-speed resolver may be provided on a first surface of the rotor substrate and other portions of the conductors for both the 1-speed resolver and the 16-speed resolver may be provided on the second, opposite surface of the rotor substrate.

In the example embodiment of FIGS. 6A-6B, the 1-speed resolver conductors may be the same as or similar to the one speed resolver circuitry and conductors described above in conjunction with FIGS. 1A-1D and 2A-2E and thus like elements of the 1-speed resolver conductors of FIGS. 6A, 6b are provided having the same reference designations as the 1-speed resolver conductors of FIGS. 2A-2E.

The multi-speed resolver comprises a multi-speed excitation circuit implemented as and comprising a plurality of sinusoidally-shaped conductors 156a, 156b. Conductors 156a, 156b are physically spaced apart from each other by gaps 157 which exist between the conductors 156a, 156b. Thus, conductors 156a, 156b are not in physical or electrical contact with each other.

Conductors 156a form a first multi-speed excitation circuit and conductors 156b form a second multi-speed excitation circuit. Conductors 158 (FIG. 6B) couple conductors 156a to a first multi-speed transmission conductor 160. Similarly, conductors 162 couple conductors 156b to a second multi-speed transmission conductor 164.

Shielding conductor 35b′ is disposed between and spaced apart from transmission conductors 64, 164.

As described in conjunction with FIGS. 3A-5B, the first multi-speed excitation sinusoid circuit provided by conductors 156a receives a first multi-speed excitation signal MS 1 and the second multi-speed excitation sinusoid circuit provided by conductors 156b receives a second multi-speed excitation signal M̅S̅ 1̅ which is in antiphase to the first multi-speed excitation signal MS 1.

Thus, in embodiments, the rotor of a multi-excitation, multi-speed resolver may comprise a first set of conductors disposed on the first surface of the rotor including a first conductor disposed to receive a first excitation sinusoidal signal, a second conductor disposed to receive a second excitation sinusoidal signal which is in antiphase to the first single-speed excitation signal.

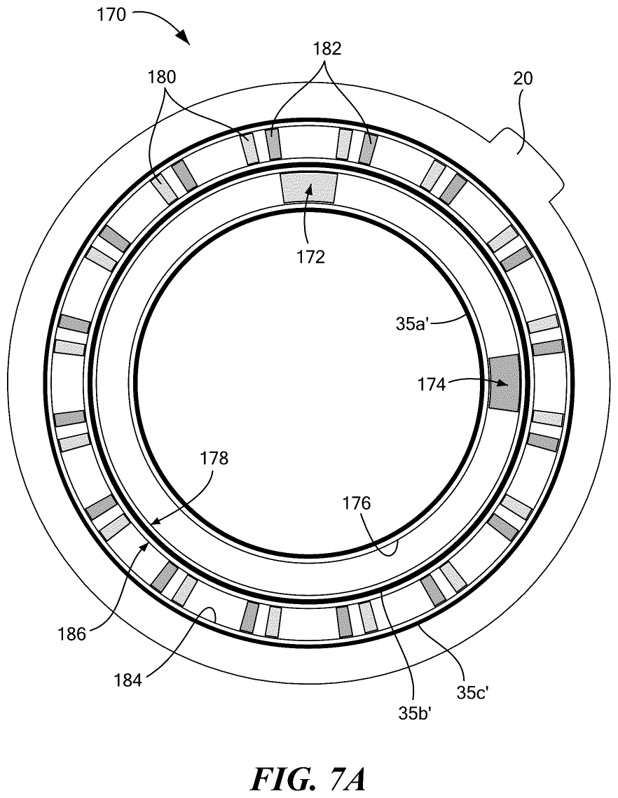

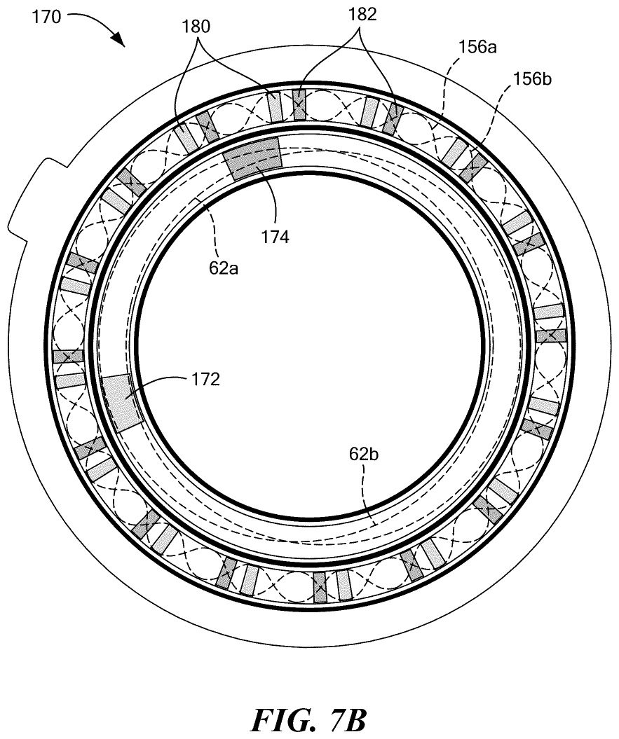

Referring now to FIGS. 7A, 7B, a stator 170 of a multi-excitation, multi-speed resolver suitable for use with the rotor of FIGS. 6A, 6B includes first and second single-speed output pickup conductors 172, 174 disposed on the stator (e.g., disposed on a surface of a stator substrate) and arranged to intercept (or overlap) single-speed excitation conductors (such as conductors 62a, 62b in FIG. 6A 6B). As illustrated, output pickup conductors 172, 174 are 90 degrees out of phase (i.e., are physically spaced apart by 90 degrees). Also disposed on the stator are single-speed transmission conductors 176, 178 and shielding conductors 35a′,35b′, 35c′. The single-speed transmission conductors 176, 178 are disposed on the stator such that when a rotor and the stator are aligned (e.g., concentrically aligned) and in proximity, the single-speed transmission conductors are each capacitively coupled to a respective one of single-speed transmission conductors on the rotor (e.g., single-speed transmission conductors 64, 66 in FIGS. 6A, 6B).

Thus, as may be most clearly seen in FIG. 7B, each resolver has output pickup conductors 172, 174 that overlay the sinusoidally-varying conductors provided (e.g. patterned or otherwise provided) on the rotor (e.g., conductors 62a, 62b in FIG. 6A). As the sinusoidally-shaped conductors (e.g., conductors 62a, 62b in FIG. 6A) provided on the rotor travel past output pickup conductors 172, 174 the amount of overlapping conductor area changes (i.e. due to the changing shape of the sinusoidally-shaped conductors). This, in turn, changes the capacitance which exists between the stator single-speed output pickup conductors 172, 174 and the rotor conductors 62a, 62b. The changing capacitance between output pickup conductors 172, 174 and the sinusoidally-shaped conductive pattern on the rotor creates quadrature signals encoding rotation angle.

Stator 170 further includes first and second multi-speed output pickup conductors 180, 182 disposed on the stator and arranged to intercept (or overlap) multi-speed excitation conductors (such as conductors 156a, 156b in FIG. 6A 6B). Also disposed on the stator are multi-speed transmission conductors 184, 186. The multi-speed transmission conductors 184, 186 are disposed on the stator such that when a rotor and the stator are aligned (e.g., concentrically aligned) and in proximity, the multi-speed transmission conductors 184, 186 are each capacitively coupled to a respective one of multi-speed transmission conductors on the rotor (e.g., multi-speed transmission conductors 160, 164 in FIGS. 6A, 6B).

Thus, as may also be most clearly seen in FIG. 7B, each resolver has output pickup conductors 180, 182 that overlay the sinusoidally-varying conductors 156a, 156b (FIG. 6A), which may be patterned or otherwise provided on the rotor. As the sinusoidally-shaped conductors (e.g., conductors 156a, 156b in FIG. 6A) provided on the rotor travel past output pickup conductors 180, 182 the amount of overlapping conductor area changes (e.g., due to the changing shape of the sinusoidally-shaped conductors). This, in turn, changes the capacitance which exists between the stator output pickup conductors 180, 182 and the rotor conductors 156a, 156b. The changing capacitance between output pickup conductors 180, 182 and the sinusoidally-shaped conductors 156, 156B on the rotor creates quadrature signals encoding rotation angle.

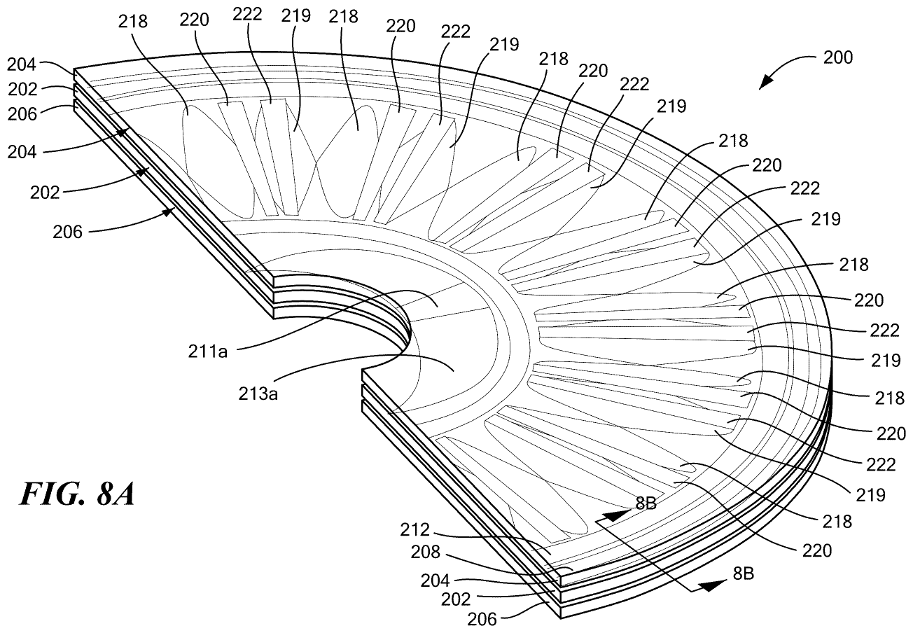

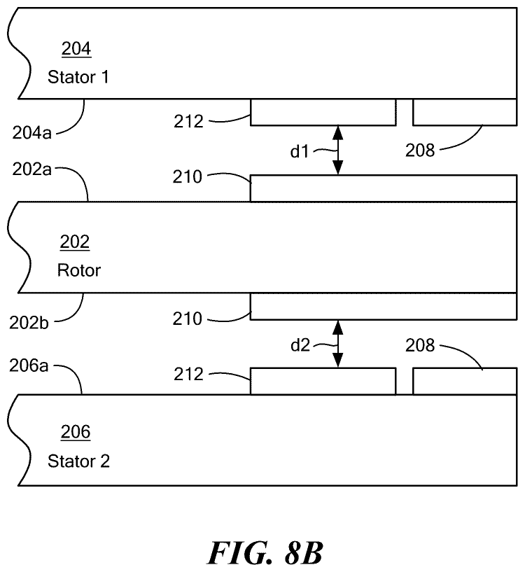

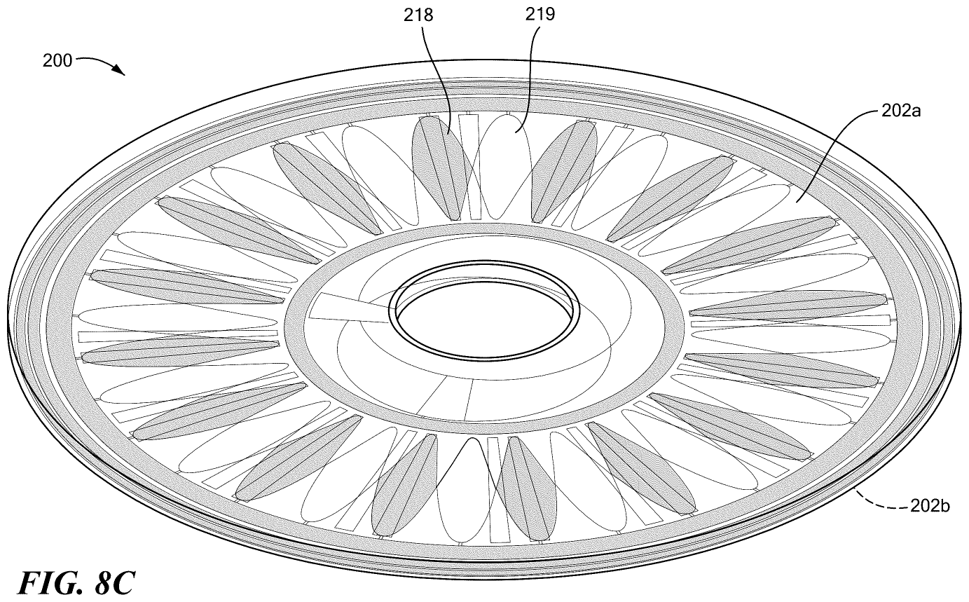

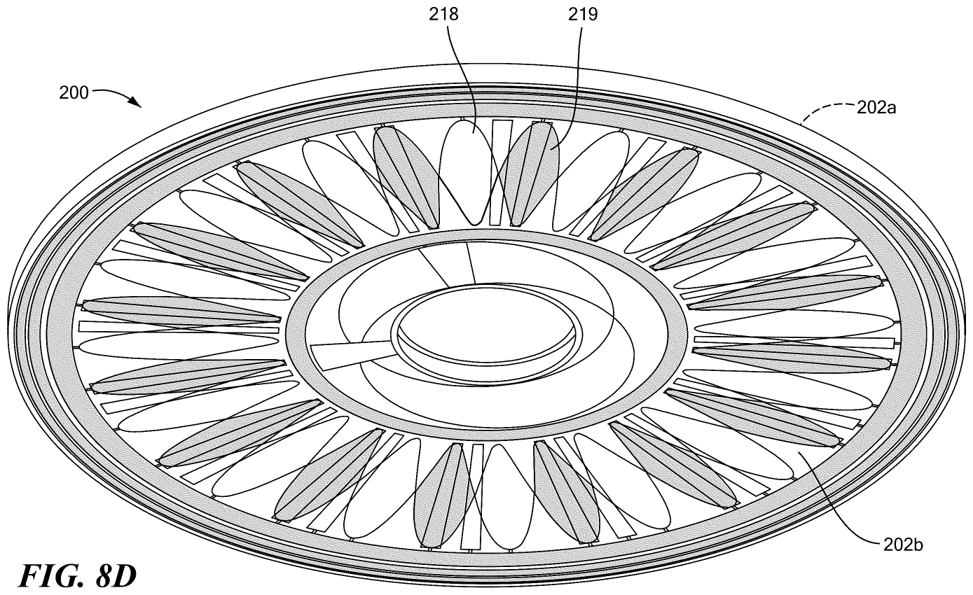

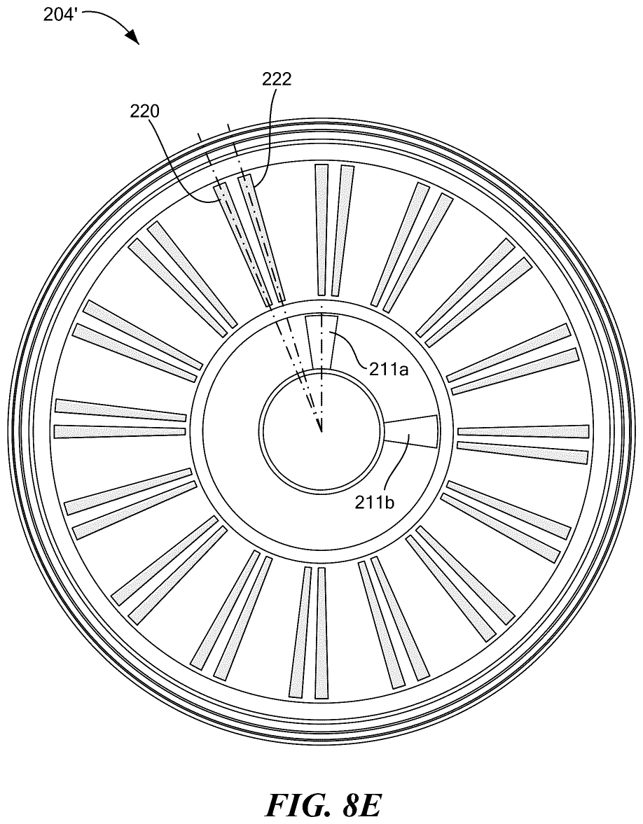

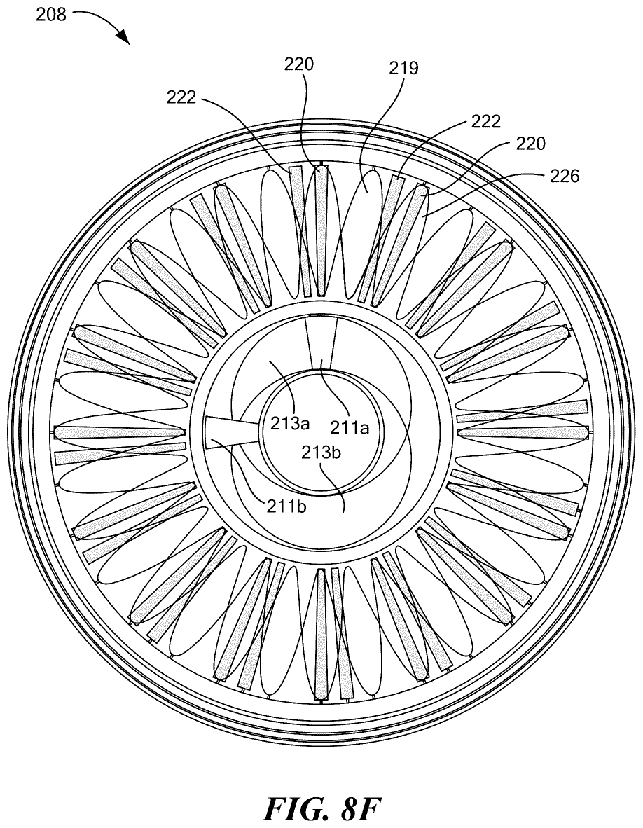

Referring now to FIG. 8A-8F in which like elements are provided having like reference designations, a multi-excitation capacitive resolver may also comprise multiple ones of rotors and/or stators arranged in a stack (that is multi-excitation capacitive resolver may be configured in a multi-layer stack). In the example embodiment of FIGS. 8A-8F, a multi-excitation capacitive resolver is illustrated as a three-layer stack. As will be described below, multi-layer stacks allow for a differential axial displacement measurement. In embodiments, such a differential axial displacement measurement may be used, for example, to remove error associated with gap change (e.g. a change in the gap width between a surface of a rotor and a surface of a stator). In embodiments, such a multi-layer stack capacitive resolver may be used to measure both angular position as well axial displacement.

FIGS. 8A, 8B illustrate an example multi-excitation, multi-layer stack capacitive resolver comprising rotor 202 having first and second stators 204, 206 disposed over opposing surfaces 202a, 202b thereof. The multi-excitation, multi-layer stack capacitive resolver also includes an axial displacement sensor.

The axial displacement sensor comprises a set of transmission conductors 208 (FIG. 8B) and output conductors 212 (FIG. 8B) disposed on stator surfaces 204a, 206a. The transmission conductors 208 and output conductors 212 are disposed over and spaced apart from (i.e., not in physical contact with) sensing conductors 210 which are disposed on rotor surfaces 202a 202b. An excitation signal may be provided to transmission conductors 208 which couples, transmits or otherwise provides the excitation signal to rotor sensing conductors 210. By arranging surfaces of output conductors 212 proximate to (but not in physical contact with) surfaces of respective ones of sensing conductors 210, a capacitance exists between the output conductors 212 and sensing conductors 210. In response to changes in either or both of distances d1, d2, the capacitance between the output conductors 212 and sensing conductors 210 changes. That is, as either of the distances d1, d2 change, there is a resulting change in capacitance between the respective output conductors 212 and sensing conductors 210. Such changes in capacitance may thus be used to measure axial displacement between opposing surfaces of stators 204, 206 and rotor 202.

The multi-excitation, multi-layer stack capacitive resolver illustrated in FIG. 8A is made transparent to reveal first and second excitation conductors 218, 219 which may be disposed on opposing surfaces 202a, 202b of rotor 202 (i.e., in embodiments, conductors 218 may be disposed on surface 202a and conductors 219 may be disposed on surface 20b). Also visible in the transparent view of FIG. 8A are output pickup conductors 220, 222 which are disposed on respective ones of stator surfaces 204a, 206a. For example, output pickup conductors 220 may be disposed on surface 204a of stator 204 and output pickup conductors 222 may be disposed on surface 206a of stator 206).

Referring now to FIGS. 8C, 8D, rotor 202 includes excitation conductors 218, 219 disposed on first and second opposing surfaces 202a, 202b thereof (i.e., one excitation conductor is located on a first surface of the rotor 202 and one excitation conductor is located on a second opposing surface of the rotor 202 ). In FIG. 8C, excitation conductor 218 is shown shaded to indicate it is on rotor surface 202a. In FIG. 8D, excitation conductor 219 is shown shaded to indicate it is on rotor surface 202b. In embodiments, the rotor may be provided from a single substrate. In this example embodiment, the rotor conductors 218 to receive a first excitation signal are disposed on surface 202a (FIG. 8C) of the rotor and the rotor conductors 219 to receive a second excitation signal which is in antiphase to the first excitation signal are disposed on surface 202b (FIG. 8D) of the rotor.

Referring now to FIG. 8E, a stator 204′ which may be the same as or similar to stators 204, 206 in FIGS. 8A, 8B includes sixteen (16) sets of conductors 220, 222 (or “fingers”) which serve as multi-speed sensors and a pair of conductors 211a, 211b which serve as single-speed sensors to thus provide the stator 204′ as operative for a 16-speed resolver. The single-speed conductors 211a, 211b are shown as being located on a stator 90° apart. In embodiments comprising multiple stators, a first one of the single-speed conductors 211a, 211b may be disposed on a surface of a first stator and a second one of the single-speed conductors 211a, 211b may be disposed on a surface of a second, different stator. For example, in one embodiment, conductor 211a may be disposed on stator surface 204a (FIG. 8A) and conductors 211b may be disposed on stator surface 206a (FIG. 8B).

FIG. 8F is a transparent view of a stack of rotor 202 and stators 204. 206. It is noted that conductors 220, 222 line up on both stators 204, 206 but because the conductors only overlap on one side or the other only one stator at a time detects a signal from conductors on the rotor. Conductors 220, 222 on respective ones of stators 204, 206 detect signals based upon angular position within a resolver period (i.e., 0° to 90°=stator A only; 90° to 180°=stator A&B; 180° to 270°=stator B only; 270° to 360° stator A&B).

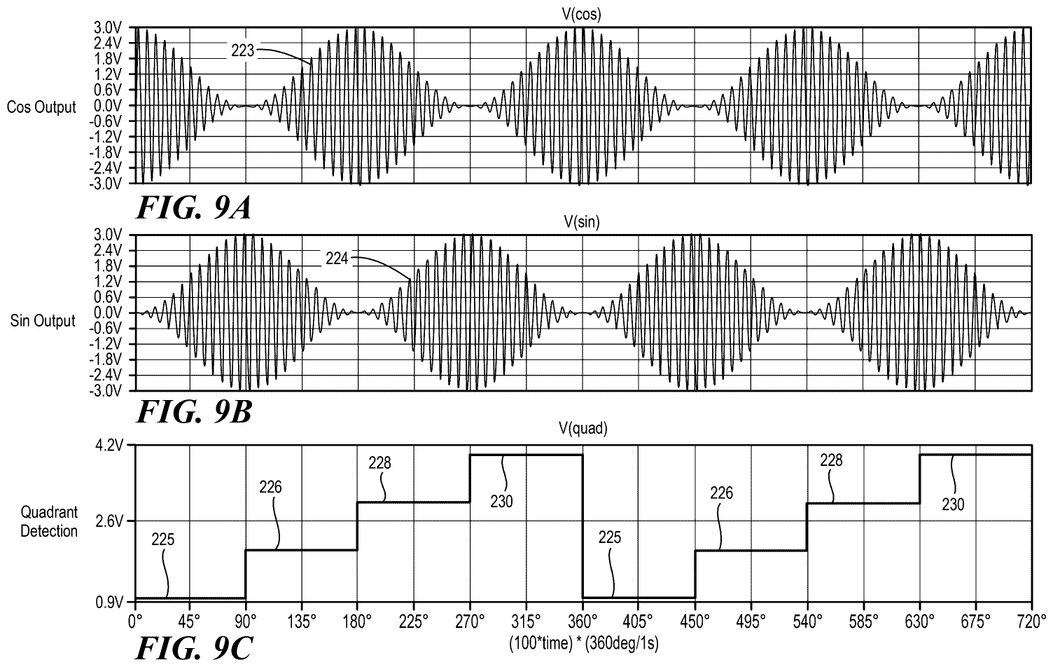

Referring now to FIGS. 9A-9C shown are plots of first and second outputs 223, 224 (labeled as Cos Output—FIG. 9A; Sin output—FIG. 9B) and quadrant detection (FIG. 9C) for a multi-excitation capacitive resolver provided in accordance with the concepts described herein. As can be seen from curves 225-230 sensor output signals from a multi-excitation capacitive resolver provided in accordance with the concepts described herein produce expected detection in each quadrant of a 360° rotation of a rotor, thereby enabling position detection around a 360° rotation.

It is noted that FIGS. 9A-9C demonstrate that a multi-excitation capacitive resolver provided in accordance with the concepts described herein can faithfully produce output signals substantially matching output signals provided by traditional electro-magnetic resolver systems. Thus, capacitive resolvers provided in accordance with the concepts described herein are “backwards compatible” with existing electro-magnetic system read electronics. As can be seen by comparing signals 220 (FIGS. 9A) and 222 (FIG. 9B), a phase change occurs which is what allows detection of quadrants.

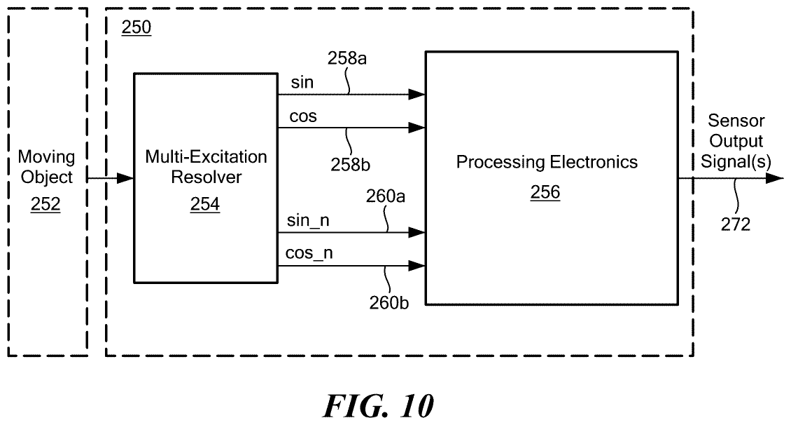

Referring now to FIG. 10, a sensor 250 comprises a multi-excitation resolver 254, which may be the same as or similar to any of the multi-excitation resolvers described above in conjunction with FIGS. 1-8F or which may be a linear resolver provided in accordance with the concepts described herein. Sensor 250 is coupled to a moving object 252 (e.g., a rotating object or a translating object (e.g., an object moving along a linear or substantial linear path)). Object 252 is here shown in phantom since it is not properly a part of the sensor 250.

Sensor 250 may be coupled to moving object 252, for example, by physically coupling a rotor of the multi-excitation resolver to the moving object. A stator of the multi-excitation resolver may be disposed proximate the rotor so as to be in electrical communication with the rotor, but the stator is stationary while the rotor is capable of moving as the object moves. As described above, as rotor circuitry moves relative stator circuitry, the multi-excitation resolver generates two pairs of sinusoidal output signals 258a, 258b and 260a, 260b.

Sensor 250 further includes processing electronics 256 coupled to receive signals provided thereto from multi-excitation resolver 254. Processing electronics 256 receives the signals provided thereto and processes the signals to produce one or more sensor output signals 272.

If multi-excitation resolver 254 comprises a one-speed excitation circuit and a multi-speed excitation circuit (e.g. a 16-speed excitation circuit as described above at least in conjunction with FIGS. 6A,6B), then one pair of resolver signals (e.g., signals 258a, 258b) correspond to single-speed signals (e.g., SIN, COS) and the other pair of resolver signals (e.g., signals 260a, 260b) correspond to multi-speed (e.g., 16-speed) signals SIN_N, COS_N where N represents the speed (e.g., in a 16 speed resolver N=16 indicating a 16 speed resolver). Thus, processing electronics 256 has one or more inputs at which may be provided a first pair of signals corresponding to an excitation frequency signal at a first speed (e.g. a single-speed excitation) and a second pair of signals corresponding to an excitation frequency signal at a second speed (e.g. 16-speed excitation).

In embodiments, processing electronics may comprise a combination of analog and digital circuitry. After reading the disclosure provided herein, one of ordinary skill in the art will appreciate how to process signals generated by a multi-excitation resolver provided in accordance with the concepts described herein.

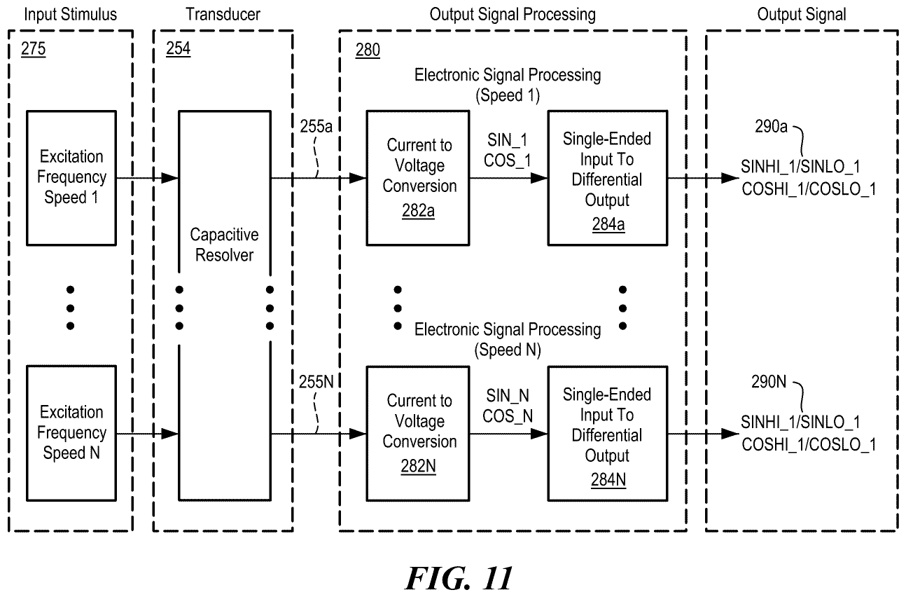

Referring now to FIG. 11, a multi-excitation capacitance resolver, which may be the same as or similar to any of the multi-excitation resolvers described above in conjunction with FIGS. 1-10, has a plurality of inputs at which may be provided a corresponding plurality of excitation frequency signals at various speeds with N different speeds being shown in FIG. 11. In the example embodiment of FIG. 11, a first input receives a first signal illustrated as excitation frequency speed 1 and a second input receives a second signal illustrated as excitation frequency speed N. The multi-excitation resolver receives the signals provided thereto and provides resolver output signals 255a-255N at resolver outputs in the manner described above in conjunction with FIGS. 1-10.

An output signal processing circuit 280 comprises current-to-voltage converter circuits 282a-282N. Resolver output signals for the first speed are coupled to inputs of a first one of the current-to-voltage converter circuit while resolver outputs for the N speed are coupled to inputs of a second one of the current-to-voltage converter circuits.

Current-to-voltage converter circuits may receive current signals provided thereto and provide corresponding sinusoidal voltage signals at outputs thereof. It is noted that in embodiments, current-to-voltage converter circuits 282a-282N may each provide one output, in which case two current-to-voltage converter circuits would be required to process signals (e.g. Sin and Cos signals as described above in conjunction with FIG. 10). The output signals from the current-to-voltage converter circuits are provided to respective ones of circuits 284a-284N which accept single-ended input signals and provide differential output signals 290a-290N at outputs thereof.

It is noted that to promote clarity in the description of FIG. 11, the multi-excitation resolver is illustrated as receiving a pair of excitation frequency signals, however, it should be appreciated that multi-excitation resolver may receive more than two excitation frequency signals (e.g., the multi-excitation resolver 255 may receive N excitation frequency signals where N is an integer greater than or equal to two). It should also be appreciated that in response to the N excitation frequency signals, the multi-excitation resolver provides a corresponding number of output signals which are processed via the output signal processing circuit to provide resolver output signals.

It should be noted that output signal processing (e.g. the processing performed by circuitry which may be the same as or similar to the example circuit of FIG. 11) may be provided by a circuit which is local to (i.e. a part of) or remote from (i.e., a separate circuit) the transducer.

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable sub combination. Other embodiments not specifically described herein are also within the scope of the following claims.

Various embodiments of the concepts, systems, devices, structures and techniques sought to be protected are described herein with reference to the related drawings. Alternative embodiments can be devised without departing from the scope of the concepts, systems, devices, structures and techniques described herein.

The simplicity of the multi-excitation capacitive resolver described herein makes such multi-excitation capacitive resolvers appropriate for use in a wide variety of applications including, but not limited to: servo motor feedback, speed and position feedback, oil and gas production operations, engine fuel systems (including but not limited to jet engine fuel systems), aircraft flight surface actuators, communication position systems, control systems (including but not limited to control systems in land and water based vehicles including both commercial and military vehicles).

It is noted that various connections and positional relationships (e.g., over, below, adjacent, etc.) may be set forth between elements in the above description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship. Thus, the terms “connection” or coupling (or variations thereof) can include an indirect “connection” or “coupling” and a direct “connection” or “coupling. ” The term “direct connection” or “direct coupling” (and variants thereof) means that a first element, such as a first structure or first circuit element, and a second element, such as a second structure or a second circuit element, are connected without any intermediary elements. Further, the terms “connection” or coupling (or variations thereof) can include couplings through various forms of conductors, vias, busbars, etc.

The surface of a rotor or stator, and/or any components disposed thereon can be disposed on, within, or a combination thereof. The surface is not intended to be limiting to an external surface. Components described herein can extend or distend from or into the rotor and/or stator. The surface of the rotor and/or stator can have a depth extending into the rotor and/or stator.

Any of the components described herein (e.g., any of the conductors) can exist in multiples. The descriptions herein are not meant to be limiting in quantity of conductor.

The following definitions and abbreviations are to be used for the interpretation of the claims and the specification. As used herein, the terms “comprises,” “comprising, “includes,” “including,” “has,” “having,” “contains” or “containing,” or any variations thereof, are intended to cover a non-exclusive inclusion. For example, a circuit, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs.

The terms “one or more” and “at least one” are understood to include any integer number greater than or equal to one, i.e., one, two, three, four, etc. The terms “a plurality” are understood to include any integer number greater than or equal to two, i.e., two, three, four, five, etc.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately,” “about,” substantially,” and “substantially equal to” may be used to mean within ±20% of a target value in some embodiments, within ±10% of a target value in some embodiments, within ±5% of a target value in some embodiments, and yet within ±2% of a target value in some embodiments. The terms “approximately,” “about,” “substantially,” and “substantially equal to” may include the target value. The terms “approximately,” “about,” “substantially and “substantially equal to” may also be used to refer to values that are within ±20% of one another in some embodiments, within ±10% of one another in some embodiments, within ±5% of one another in some embodiments, and yet within ±2% of one another in some embodiments.

The terms “approximately,” “about,” “substantially” and “substantially equal to” may also be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A rotor for use in a resolver, the rotor comprising:
a rotor substrate having first and second opposing surfaces; and
first and second sets of conductors having a sinusoidally varying shape disposed on at least one of the first and second opposing surfaces of the rotor with the first set of conductors arranged to provide a single-speed resolver excitation circuit and the second set of conductors arranged to provide a multi-speed resolver excitation circuit.

2. The rotor of claim 1 wherein:
(a) the first set of conductors comprises:
a first conductor which forms a first portion of a single-speed excitation circuit;
a second conductor which forms a second portion of the single-speed excitation circuit with the first conductor being electrically separate from the second conductor;
a first transmission signal conductor coupled to the first conductor; and
a second, different transmission signal conductor, electrically separate from the first transmission signal path coupled to the second conductor.

3. The rotor of claim 1 wherein:
(a) the second set of conductors comprises:
a first plurality of conductors which form a first portion of the multi-speed excitation circuit;
a second plurality of conductors which form a second portion of the multi-speed excitation circuit with the second plurality of conductors being electrically isolated from the first plurality of conductors;
a first transmission signal path coupled to the first plurality of conductors which form the first portion of the multi-speed excitation circuit; and
a second transmission signal path coupled to the second plurality of conductors which form the second portion of the multi-speed excitation circuit.

4. The rotor of claim 1 wherein:
(a) the first set of conductors disposed on the rotor comprises:
a first conductor which forms a first portion of a single-speed excitation circuit;
a second conductor which forms a second portion of the single-speed excitation circuit with the first and second conductors electrically separate;
a first transmission signal path coupled to the first conductor; and
a second, different transmission signal path, electrically separate from the first transmission signal path coupled to the second conductor.
(b) the second set of conductors disposed on the rotor comprises:
a first plurality of conductors which form a first portion of the multi-speed excitation circuit;
a second plurality of conductors which form a second portion of the multi-speed excitation circuit with the second plurality of conductors being electrically isolated from the first plurality of conductors;
a first transmission signal path coupled to the first plurality of conductors which form the first portion of the multi-speed excitation circuit; and
a second transmission signal path coupled to the second plurality of conductors which form the second portion of the multi-speed excitation circuit.

5. The rotor of claim 1 wherein the first transmission signal path is provided having an annular shape.

6. The rotor of claim 1 wherein the second transmission signal path is provided having an annular shape.

7. The rotor of claim 2 wherein the first set of conductors are disposed on the same surface of the rotor substrate.

8. The rotor of claim 3 wherein the second set of conductors are disposed on the same surface of the rotor substrate.

9. The rotor of claim 1 wherein the first and second sets of conductors are disposed on the same surface of the rotor substrate.

10. The rotor of claim 1 wherein:
the first set of conductors are disposed on a first one of the first and second opposing surfaces of the rotor substrate; and
the second set of conductors are disposed on a second one of the first and second opposing surfaces of the rotor substrate.

11. A multi-excitation resolver comprising:
a rotor substrate having first and second opposing surfaces with first and second sets of conductors disposed on at least one of the first and second opposing surfaces of the rotor with the first set of conductors arranged to provide a one-speed resolver excitation circuit and the second set of conductors arranged to provide a multi-speed resolver excitation circuit; and
a stator having first and second opposing surfaces, with third and fourth sets of conductors disposed on at least one of the first and second opposing surfaces of the stator with the third set of conductors arranged to provide a one-speed resolver output pickup circuit and the fourth set of conductors arranged to provide a multi-speed resolver output pickup circuit wherein a first one of the first and second opposing surfaces of the stator are disposed over a first one of the first and second surfaces of the rotor such that a capacitive gap exists between at least some of the first and second conductors on the rotor and at least some of the third and fourth conductors of the stator.

12. The multi-excitation resolver of claim 11, wherein:
the rotor is movable relative to the stator; and
in response to relative movement between the rotor and the stator, at least portions of the first and second sets of conductors overlap at least portions of the third and fourth sets of conductors to form one or more overlapping areas having a sinusoidally varying shape.

13. The stator of claim 11 wherein the one-speed resolver output pickup circuit is at an offset between 80-100 degrees from the multi-speed resolver output pickup circuit.

14. The multi-excitation resolver of claim 11 wherein:
(a) the first set of conductors on the rotor comprise:
a first conductor which forms a first portion of a single-speed excitation circuit;
a second conductor which forms a second portion of the single-speed excitation circuit with the first and second conductors being electrically separate;
a first transmission conductor coupled to the first conductor; and
a second, transmission conductor, electrically separate from the first transmission signal path coupled to the second conductor.

15. The multi-excitation resolver of claim 11 wherein:
(a) the second set of conductors comprises:
a first plurality of conductors which form a first portion of the multi-speed excitation circuit;
a second plurality of conductors which form a second portion of the multi-speed excitation circuit with the second plurality of conductors being electrically isolated from the first plurality of conductors;
a first transmission signal conductor coupled to the first plurality of conductors which form the first portion of the multi-speed excitation circuit; and
a second transmission signal conductor coupled to the second plurality of conductors which form the second portion of the multi-speed excitation circuit.

16. The multi-excitation resolver of claim 11 wherein:
(a) the first set of conductors disposed on the rotor comprises:
a first conductor which forms a first portion of a single-speed excitation circuit;
a second conductor which forms a second portion of the single-speed excitation circuit with the first and second conductors are electrically separate;
a first transmission signal path coupled to the first conductor; and
a second, different transmission signal conductor, electrically separate from the first transmission signal path coupled to the second conductor. one or more shielding conductors disposed about the first set of conductors;
(b) the second set of conductors disposed on the rotor comprises:
a first plurality of conductors which form a first portion of the multi-speed excitation circuit;
a second plurality of conductors which form a second portion of the multi-speed excitation circuit with the second plurality of conductors being electrically isolated from the first plurality of conductors;
a first transmission signal conductor coupled to the first plurality of conductors which form the first portion of the multi-speed excitation circuit; and
a second transmission signal conductors coupled to the second plurality of conductors which form the second portion of the multi-speed excitation circuit; and
one or more shielding conductors disposed about the second set of conductors.

17. The multi-excitation resolver of claim 11 wherein:
the first set of conductors are disposed on the first one of the first and second opposing surfaces of the rotor the second set of conductors are disposed on the first one of the first and second opposing surfaces of the rotor;
the third set of conductors are disposed on the first one of the first and second opposing surfaces of the stator; and
the fourth set of conductors are disposed on the first one of the first and second opposing surfaces of the stator.

18. The multi-excitation resolver of claim 11 wherein the stator comprises an input for receiving multiple excitation signals that are antiphase to each other on each half of a resolver period such that in response to receiving multiple excitation signals, an output signal of the resolver generates a phase change when crossing a resolver period.

19. The multi-excitation resolver of claim 11 further comprising a spacer disposed to position the first surface of the rotor and the first one of the first and second opposing surfaces of the stator a selected distance apart.

20. The multi-excitation resolver of claim 11, wherein the rotor or the stator comprises a generally planar substrate.
